(19) United States
(12) Patent Application Publication
(10) Pub. No.: US 2021/0023727 A1
(43) Pub. Date: Jan. 28, 2021

(54) CUTTER

(71) Applicant: Hsiu-Man Yu Chen, Taichung (TW)

(72) Inventor: Hsiu-Man Yu Chen, Taichung (TW)

(21) Appl. No.: 16/522,664

(22) Filed: Jul. 26, 2019

(51) Int. Cl. B26B 5/00

(52) U.S. Cl. CPC B26B 5/00

(57) ABSTRACT

A cutter includes a main body, a cutting unit, a cover, and a covering layer. The main body has a first end, a second end, a first surface, and a second surface. The cutting unit is coupled to the first end. The cover is assembled and secured to an accommodating cavity of the first surface. The covering layer covers a first side and a second side of the main body and the accommodating cavity. Thereby, the cutting unit can be quickly replaced and the diversity of products can be achieved through different covers.

### FIELD OF THE INVENTION

The present invention relates to a cutter, and more particularly to a cutter able to cut and remove various kinds of packaging members.

### BACKGROUND OF THE INVENTION

A conventional cutter has a grip portion and a cutting portion that are integrally formed. In order to highlight the trademark, character or logo of the cutter, the front of the grip portion is provided with a design unit for expressing a design or character, so that the character or logo of the trademark can be highlighted.

However, in order to provide the character or logo of the trademark on the cutter, it is necessary to make corresponding molds for different trademarks. Since the shapes and sizes of various molds are different, the cost of the molds will be greatly increased. If the cutter is used for cutting or scraping for a long time, the cutting head of the cutter may be broken or damaged. The cutter can no longer be used and needs to be replaced with a new one, which is inconvenient for use. Accordingly, the inventor of the present invention has devoted himself based on his many years of practical experiences to solve these problems.

### SUMMARY OF THE INVENTION

The primary object of the present invention is to provide a cutter having a cutting unit that can be quickly replaced. The diversity of products can be achieved through different covers.

In order to achieve the aforesaid object, the cutter of the present invention comprises a main body, a cutting unit, a cover, and a covering layer. The main body has a first end, a second end, a first surface, and a second surface. The first end is provided with a positioning slot. One end of the positioning slot has an opening at the first end. Another end of the positioning slot is in communication with a receiving groove. The first surface has a limiting cavity and an accommodating cavity. The limiting cavity is in communication with the receiving groove. The limiting cavity is provided with a through hole passing through the second surface. The accommodating cavity is provided with at least one first coupling portion. The cutting unit is coupled to the first end of the main body. The cutting unit includes a cutting head, a blade, a positioning block, and a resilient arm. The cutting head is provided with an accommodating space. The blade is inserted through the accommodating space. One end of the positioning block is connected to the cutting head, and another end of the positioning block is connected to the resilient arm. A free end of the resilient arm is provided with a fastening portion. The cover has a top surface and a bottom surface. The top surface is provided with a design unit. The bottom surface is provided with at least one second coupling portion. The second coupling portion is assembled and secured to the first coupling portion so that the cover is assembled and secured to the accommodating cavity. The covering layer covers the accommodating cavity, a first side and a second side of the main body.

In the cutter provided by the present invention, the free end of the resilient arm is provided with the fastening portion. When the user presses the fastening portion in the limiting cavity, the fastening portion is disengaged from the peripheral wall of the limiting cavity and pushed forwardly, so that the cutting unit can be detached from the main body for replacing the cutting unit quickly. The diversity of products can be achieved through different covers.

### BRIEF DESCRIPTION OF THE DRAWINGS

FIG. 1 is a perspective view in accordance with a first embodiment of the present invention;

FIG. 2 is a front view in accordance with the first embodiment of the present invention;

FIG. 3 is an exploded view in accordance with the first embodiment of the present invention;

FIG. 4 is another exploded view in accordance with the first embodiment of the present invention;

FIG. 5 is a partial sectional view in accordance with the first embodiment of the present invention;

FIG. 6 is a schematic view in accordance with the first embodiment of the present invention when in use; and

FIG. 7 is a perspective view in accordance with a second embodiment of the present invention.

### DETAILED DESCRIPTION OF THE PREFERRED EMBODIMENTS

Embodiments of the present invention will now be described, by way of example only, with reference to the accompanying drawings.

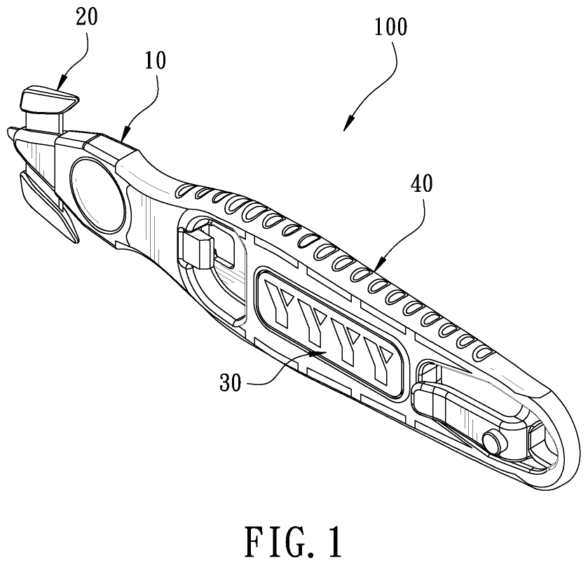

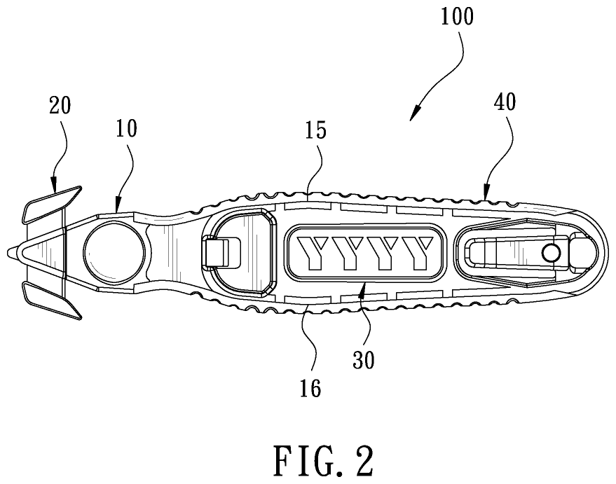

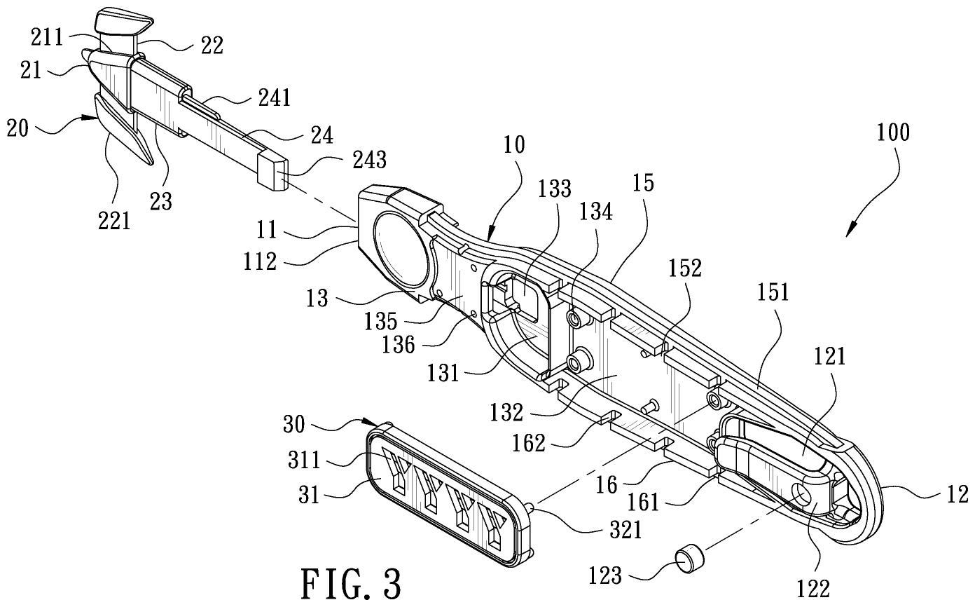

FIG. 1 is a perspective view in accordance with a first embodiment of the present invention. FIG. 2 is a front view in accordance with the first embodiment of the present invention. FIG. 3 is an exploded view in accordance with the first embodiment of the present invention. The present invention discloses a cutter 100. The cutter 100 comprises a main body 10, a cutting unit 20, a cover 30, and a covering layer 40.

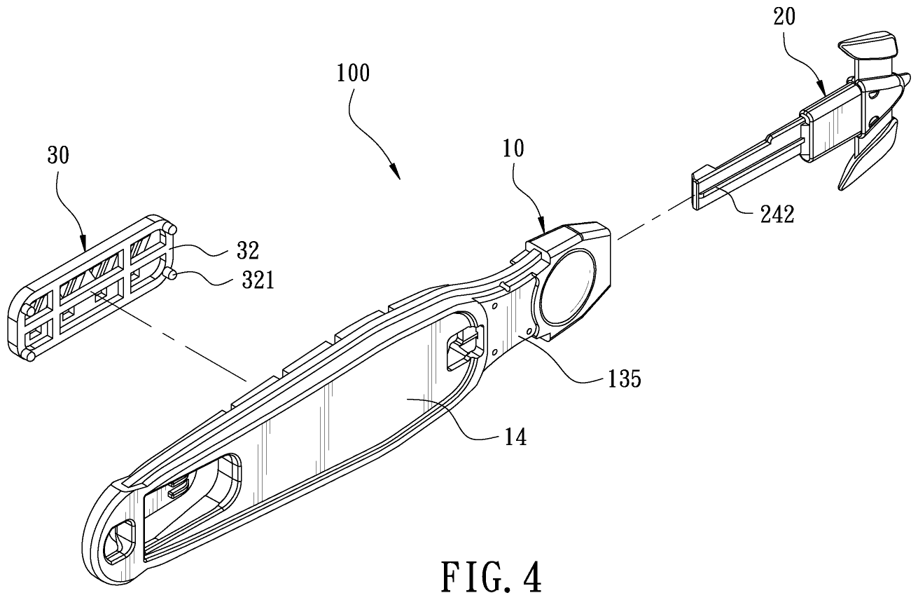

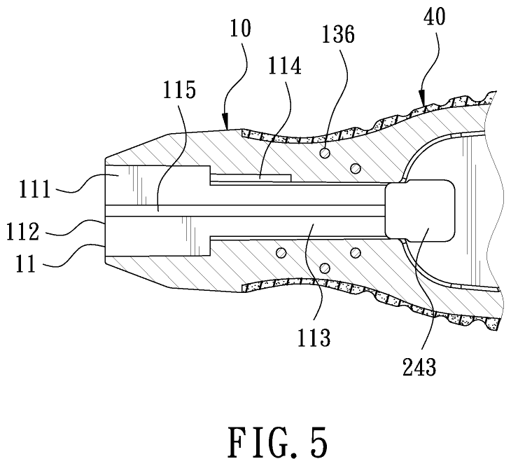

The main body 10, referring to FIG. 4 and FIG. 5, is a long strip-shaped body. The main body 10 has a first end 11 and an opposing second end 12. The main body 10 further has a first surface 13 and a second surface 14 between the first end 11 and the second end 12. The first end 11 is provided with a positioning slot 111. One end of the positioning slot 111 has an opening 112 at the first end 11, and another end of the positioning slot 111 is in communication with a receiving groove 113. One side of the receiving groove 113 is provided with a positioning groove 114. One side of the positioning slot 111 and the receiving groove 113, close to the second surface 14, is provided with a limiting groove 115. The limiting groove 115 is in communication with the opening 112. The main body 10 is provided with an elongated hole 121 located close to the second end 12 and passing through the first surface 13 and the second surface 14. The main body 10 is provided with a clamping member 122 close to the elongated hole 121. A magnet 123 is fixedly connected to the clamping member 122. The first surface 13 has a limiting cavity 131 and an accommodating cavity 132. The limiting cavity 131 is in communication with the receiving groove 113. The limiting cavity 131 is provided with a through hole 133 passing through the second surface 14. The accommodating cavity 132 is provided with at least one first coupling portion 134. In this embodiment of the present invention, the bottom of the accommodating cavity 132 is provided with a plurality of first coupling portions 134. The first coupling portion 134 is a fixing post. The fixing post has a fixing hole. The first surface 13 and the second surface 14 each have a recess 135. The recess 135 is located between the first end 11 and the limiting cavity 131. The bottom of the recess 135 is provided with a plurality of apertures 136 passing through the main body 10. A first side 15 and a second side 16 are formed between the first surface 13 and the second surface 14. The first side 15 and the second side 16 each have a rib 151, 161. The first side 15 and the second side 16 are provided with a plurality of spaced guiding grooves 152, 162, respectively. The guiding grooves 152, 162 are in communication with the accommodating cavity 132.

The cutting unit 20 is coupled to the first end 11 of the main body 10. The cutting unit 20 includes a cutting head 21, a blade 22, a positioning block 23, and a resilient arm 24. The cutting head 21 is provided with an accommodating space 211. The blade 22 is inserted through the accommodating space 211. Both sides of the blade 22 extend out of the accommodating space 211 and are provided with protection members 221. The protection members 221 are spaced apart from the main body 10. One end of the positioning block 23 is connected to the cutting head 21, and the other end of the positioning block 23 is connected to the resilient arm 24. The positioning block 23 has a thickness greater than the thickness of the resilient arm 24. One side of the resilient arm 24 is provided with a positioning rib 241. One surface of the resilient arm 24 is provided with a raised rib 242. A free end of another surface of the resilient arm 24 is provided with a fastening portion 243.

The cover 30 has a rectangular shape. The cover 30 has a top surface 31 and an opposing bottom surface 32. The top surface 31 is provided with a design unit 311. In this embodiment of the present invention, the design unit 311 may be one of a character, a symbol and a design, or a combination thereof. The design unit 311 is convexly or concavely disposed on the top surface 31 of the cover 30. The bottom surface 32 is provided with at least one second coupling portion 321. The second coupling portion 321 is assembled and secured to the first coupling portion 134, so that the cover 30 is assembled and secured to the accommodating cavity 132. In this embodiment of the present invention, the cover 30 is provided with a second coupling portion 321 corresponding to each first coupling portion 134. The second coupling portion 321 is a protrusion.

The covering layer 40 is configured to cover the accommodating cavity 132, the two recesses 135, the apertures 136, the first side 15 and the second side 16, and is filled into the design unit 311.

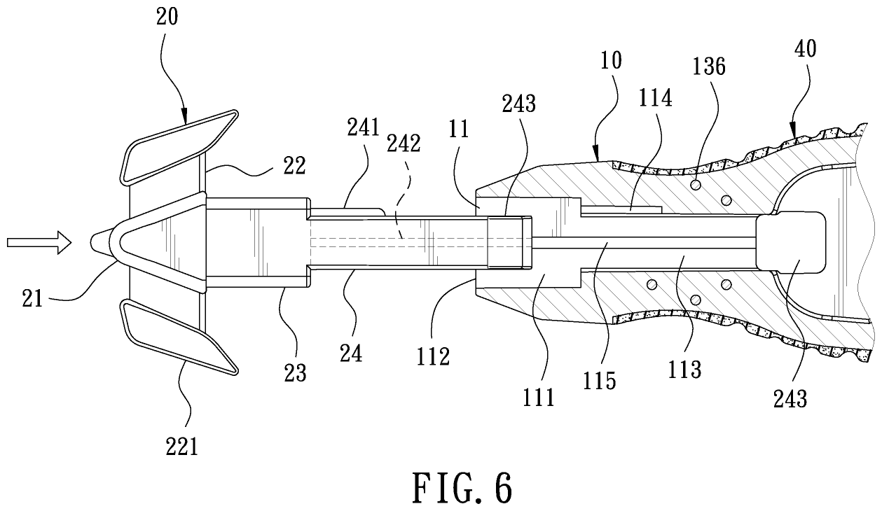

FIG. 3 is an exploded view in accordance with the first embodiment of the present invention. FIG. 6 is a schematic view in accordance with the first embodiment of the present invention when in use. After the main body 10, the cutting unit 20 and the cover 30 are respectively formed, the second coupling portion 321 of the cover 30 is first aligned with and connected to the first coupling portion 134 so that the cover 30 is fixed to the main body 10, and then the covering layer 40 is fixed to the accommodating cavity 132, the two recesses 135, the apertures 136, the first side 15 and the second side 16 by injection molding, pouring or hot pressing through a die, so as to avoid falling off during use. After that, the cutting unit 20 is aligned with and pushed in the opening 112 of the first end 11, so that the positioning block 23 is positioned in the positioning slot 111, the resilient arm 24 is secured to the receiving groove 113, the positioning rib 241 is positioned in the positioning groove 114, the raised rib 242 is positioned in the limiting groove 115, and the fastening portion 243 is engaged with the main body 10 to be positioned to the peripheral wall of the limiting cavity 131 close to the through hole 133, thereby completing the assembly of the cutter 100.

In addition, the main body 10, the cutting unit 20, and the cover 30 are separately formed, so that they are suitable for mass manufacture. The cover 30 with an appropriate design or character is further selected according to the requirement. There is no need to remake the mold of the main body 10 and the cutting unit 20, which makes the manufacture simpler and faster and can improve the variety of manufacturing the main body 10.

It is worth mentioning that the free end of the resilient arm 24 is provided with the fastening portion 243. When the cutting unit 20 is damaged or broken, the user can press the fastening portion 243 in the limiting cavity 131 to disengage the fastening portion 243 from the peripheral wall of the limiting cavity 131 and push the fastening portion 243 forwardly, so that the cutting unit 20 can be detached from the main body 10 for replacing a new cutting unit 20, thereby achieving the purpose of quickly replacing the cutting unit 20.

It is worth mentioning that the positioning rib 241 is located on one side of the resilient arm 24 and the raised rib 242 is disposed on one surface of the resilient arm 24 to limit the direction in which the cutting unit 20 is inserted in the main body 10 and to provide a reinforcement function, which can prevent the resilient arm 24 from being broken due to long-term use, thereby achieving the purpose of reducing damage.

It is worth mentioning that the clamping member 122 may be positioned at the pocket of a garment and the magnet 123 may be attached to and positioned at a predetermined position, which facilitates the user to carry the cutter 100 with him or her.

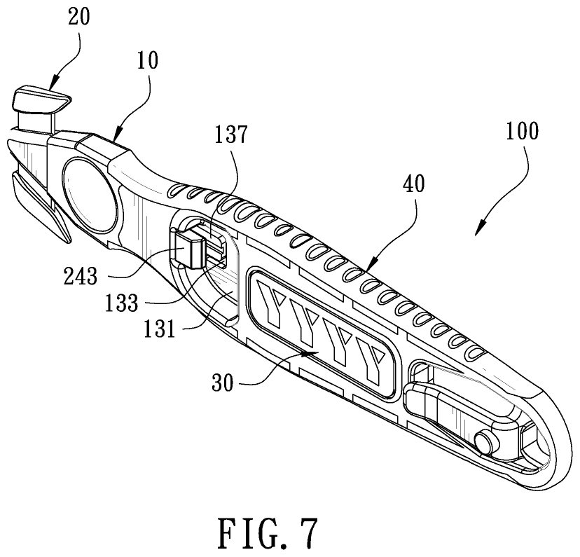

FIG. 7 is a perspective view in accordance with a second embodiment of the present invention, which is substantially similar to the first embodiment with the exceptions described hereinafter. The main body 10 is provided with a resilient member 137 in the limiting cavity 131. In this embodiment of the present invention, the resilient member 137 is a resilient plate. The resilient member 137 is located in the through hole 133 and disposed relative to the fastening portion 243. When the user presses the fastening portion 243, the fastening portion 243 is held by the resilient member 137, thereby preventing the resilient arm 24 from being broken due to excessive force.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cutter, comprising:
a main body, the main body having a first end, a second end, a first surface and a second surface, the first end being provided with a positioning slot, one end of the positioning slot having an opening at the first end, another end of the positioning slot being in communication with a receiving groove, the first surface having a limiting cavity and an accommodating cavity, the limiting cavity being in communication with the receiving groove, the limiting cavity being provided with a through hole passing through the second surface, the accommodating cavity being provided with at least one first coupling portion;
a cutting unit, coupled to the first end of the main body, the cutting unit including a cutting head, a blade, a positioning block and a resilient arm, the cutting head being provided with an accommodating space, the blade being inserted through the accommodating space, one end of the positioning block being connected to the cutting head, another end of the positioning block being connected to the resilient arm, a free end of the resilient arm being provided with a fastening portion;
a cover, the cover having a top surface and a bottom surface, the top surface being provided with a design unit, the bottom surface being provided with at least one second coupling portion, the second coupling portion being assembled and secured to the first coupling portion so that the cover is assembled and secured to the accommodating cavity;
a covering layer, covering the accommodating cavity, a first side and a second side of the main body.

2. The cutter as claimed in claim 1, wherein one side of the receiving groove is provided with a positioning groove, and one side of the resilient arm is provided with a positioning rib.

3. The cutter as claimed in claim 1, wherein one side of the positioning slot and the receiving groove, close to the second surface, is provided with a limiting groove, the limiting groove is in communication with the opening, and one surface of the resilient arm is provided with a raised rib.

4. The cutter as claimed in claim 1, wherein the first surface and the second surface each have a recess, the recess is located between the first end and the limiting cavity, and a bottom of the recess is provided with a plurality of apertures passing through the main body.

5. The cutter as claimed in claim 1, wherein the main body is provided with an elongated hole located close to the second end and passing through the first surface and the second surface, and the main body is provided with a clamping member close to the elongated hole.

6. The cutter as claimed in claim 5, wherein a magnet is fixedly connected to the clamping member.

7. The cutter as claimed in claim 1, wherein the first side and the second side are respectively formed between the first surface and the second surface, the first side and the second side each have a rib, the first side and the second side are provided with a plurality of spaced guiding grooves respectively, and the guiding grooves are in communication with the accommodating cavity.

8. The cutter as claimed in claim 1, further comprising a resilient plate, the resilient plate being located in the through hole and disposed relative to the fastening portion.

9. The cutter as claimed in claim 1, wherein the positioning block has a thickness greater than that of the resilient arm.

10. The cutter as claimed in claim 1, wherein the design unit is convexly or concavely disposed on the top surface of the cover, and the design unit is one of a character, a symbol and a design, or a combination thereof.
